(19) United States
(12) Patent Application Publication
(10) Pub. No.: US 2006/0200363 A1
(43) Pub. Date: Sep. 7, 2006

(54) Network interface card and the connection method thereof

(75) Inventor: Chia-Ching Tsai, Tainan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/365,946

(22) Filed: Mar. 2, 2006

(30) Foreign Application Priority Data
Mar. 4, 2005 (TW) 094106521

(51) Int. Cl. G06Q 99/00

(52) U.S. Cl. 705/1

(57) ABSTRACT

The present invention discloses a network interface card, adapted for connecting to an electronic device, comprising: a button; an interface, for coupling to the electronic device; a storage device, for storing a connection information and a connection program; and a network receiving module, connecting to the interface, the storage device and the button, for establishing a connection between the electronic device and an external network server through the interface; wherein, by pressing the button before the connection is established, the network receiving module is activated to execute the connection program enabling the connection information to be transmitted to the external network server for gaining the authorization of establishing the connection from the external network server, and by pressing the button after the connection is established, the connection is disconnected.

### FIELD OF THE INVENTION

The present invention relates to a connection method for network interface card, and more particularly, to a method for rapidly connecting a network interface card with Internet simply by pressing a button.

### BACKGROUND OF THE INVENTION

With rapid advance of technology, electronic devices are becoming essentials for our daily life. Among those, the portable electronic devices like mobile phone, Personal Digital Assistant (PDA), and Globe Positioning System (GPS) that can be carried while walking around had facilitated our life ever further.

As the prevailing of Internet, the demand of using those portable electronic devices for accessing the Internet wirelessly is becoming more and more popular. Therefore, it is common for a portable electronic device to equip with a network interface card.

Nevertheless, since the equipments enabling wireless connection are not massively implemented for easy access and the cost thereof is still high, a current electronic device with networking capability is not designed to connect with the Internet constantly, instead of that the electronic device is connected to the Internet after a built-in connection program is activated by a user. However, as the miniaturization of portable electronic devices, the Internet connection enabled by pressing the small buttons or by touching the small touch screen provided on the devices is becoming a troublesome task that requires a user to input the same account number and personal identification code composed of a plurality of letters and numbers for each Internet accessing. Therefore, it is in great demand to have an improve connection mechanism for easing the task.

### SUMMARY OF THE INVENTION

The primary object of the invention is to provide a connection method for network interface card, by which a user is capable of accessing to the Internet rapidly.

To achieve the above object, the present invention provides a connection method for a network interface card, being adapted for connecting an electronic device to the network interface card having a button arranged thereon, a built-in connection information and a built-in connection program, the connection method comprising the steps of:
step A: initiating the connection program by pressing the button;
step B: transmitting the connection information to an external network server by the operation of the connection program;
step C: establishing a connection with the external network server; and
step D: connecting the electronic device to the external network server through the connection by using the network interface card.

### BRIEF DESCRIPTION OF THE DRAWINGS

FIG. 1 is the architecture of a network interface card according to the present invention.

FIG. 2 is a schematic view of the first embodiment of the present invention.

FIG. 3 is a flowchart depicting the connection method of the present invention.

FIG. 4 is a schematic view of the second embodiment of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

The characteristic of the invention is to initiate a network interface card by simply pressing a button so as to establish a connection with the Internet using the information and a connection program stored inside the network interface card.

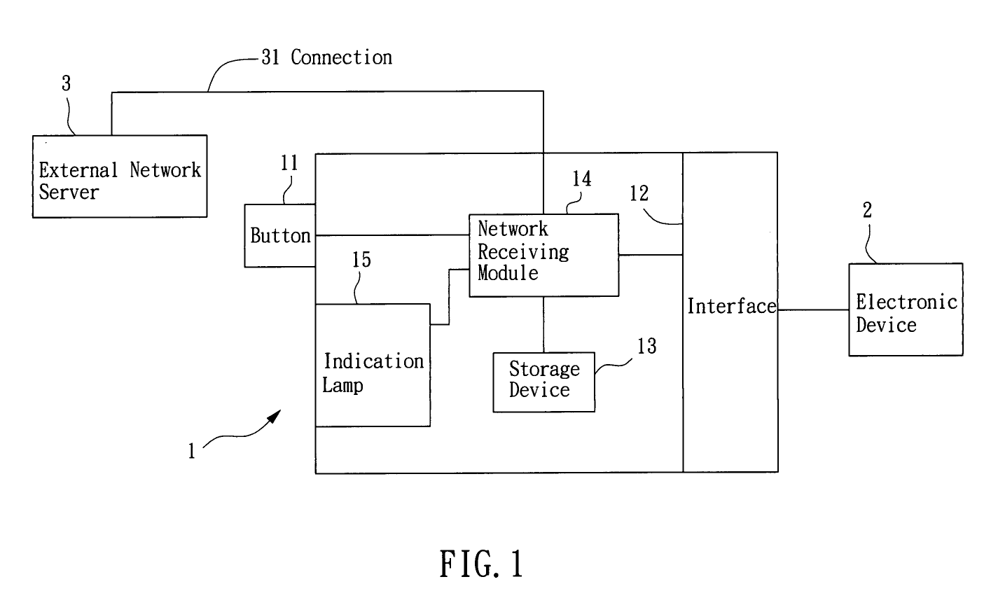

As the architecture seen in FIG. 1, the network interface card 1 of the invention is adapted to connect with an electronic device 2 such as a mobile phone, a PDA, a notebook computer, a desktop computer and so on. The network interface card 1 comprises: a button 11, for connecting or disconnecting the network interface card 1 to the Internet while it is being pressed; an interface 12, for coupling to the electronic device 2; a storage device 13, for storing a connection program and a connection information consisting a registered account number and an identification code (a password); a network receiving module 14, connecting to the interface 12, the storage device 13 and the button 11, for establishing a connection 31 between the electronic device 2 and an external network server 3 through the interface 12. When pressing the button 11 before the connection 31 is established, the network receiving module 14 is activated to execute the connection program enabling the connection information to be transmitted to the external network server 3 for gaining the authorization of establishing the connection 31 from the external network server 3. When pressing the button 11 after the connection 31 is established, the connection 31 is disconnected. In addition, a security measure is being taken for preventing the network receiving module being misused by unauthorized person, the network receiving module 14 is comparing the connection information with a primal connection information stored inside the electronic device 2 and stopping the establishing of the connection 31 while the connection information is not matched with the primal connection information. Moreover, the interface 12 can be an USB interface or a PCMCIA interface.

In a preferred embodiment, the network interface card 1 further comprises an indication lamp 15, which is connected to the network receiving module 14 for displaying the status of the connection. The electronic device 2 further comprises a download program for editing the connection information and downloading the connection information to the network interface card 1 through the interface 12.

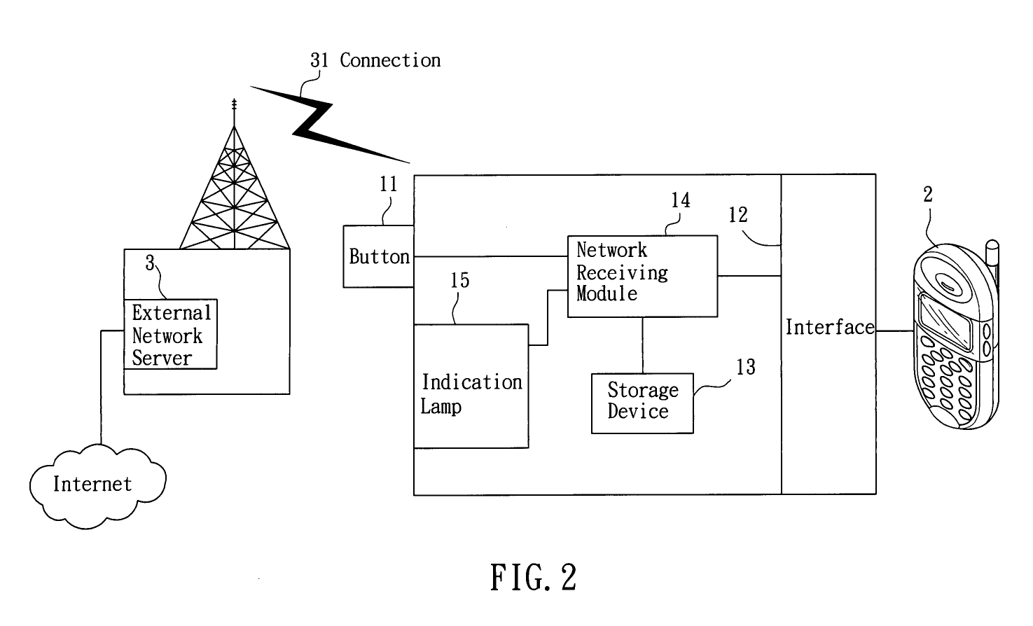

Please refer to FIG. 2, which is a schematic view of the first embodiment of the present invention. As seen in FIG. 2, the network interface card 1 of the invention is connected to a smart phone 21 such that the smart phone 21 is enabled to net surfing through the wireless communication network provided by a telecommunication company. In the preferred embodiment, the external network server is an Access Point Name (APN). Since the charging of using a smart phone for net surfing is billed to the Subscriber Identity Module (SIM) card thereof, the account number and the personal identification code for logging in the APN is fixed as seen in List 1.

List 1

| | ChungHwa | Taiwan Cellular | |
|---|---|---|---|
| | Telecom | Corp. | FarEastone |
| APN | Internet | Internet | Fetnet01 |
| Account # | Not required | Not required | fet/fet |
| password | | | |

Therefore, as the indication lamp display that the connection 31 has not yet being established, the smart phone 21 will search the nearby base stations simply by pressing the button 11 while only the base stations of the telecommunication company specified by the SIM card of the smart phone 21 will respond. Thereafter, a connection 31 between the APN of the specified telecommunication company and the network receiving module 14 can be establish while the network receiving module 14 logs in the APN and is certified by the same using the account number and the identification code stored in the storage device 13. Thus, the smart phone 21 can surf the Internet using the connection 31. In a preferred embodiment of the invention, the network receiving module 14 is capable of informing the electronic device 2, i.e. the smart phone 21, with the establishment of the connection 31 while the connection 31 is established. Further, in another preferred embodiment, the operation system (OS), e.g. Window CE, of the smart phone 21 is capable of detecting the establishment of the connection 31. Moreover, the smart phone 21 further comprises a download program for editing the connection information and downloading the connection information to the network interface card 1.

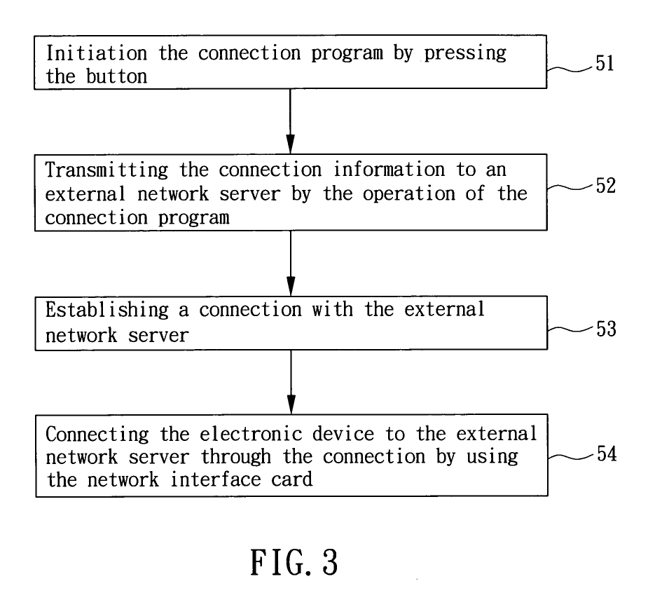

Please refer to FIG. 3 with respect to FIG. 1. As seen in FIG. 3, the connection method for a network interface card 1, being adapted for connecting an electronic device 2 like a mobile phone, a PDA, a notebook computer, a desktop computer and so on. The network interface card 1 has a button 11 arranged thereon, a built-in connection information and a built-in connection program, the connection method comprising the steps of:
step 51: initiating the connection program by pressing the button;
step 52: transmitting the connection information to an external network server by the operation of the connection program;
step 53: establishing a connection with the external network server; and
step 54: connecting the electronic device to the external network server through the connection by using the network interface card.

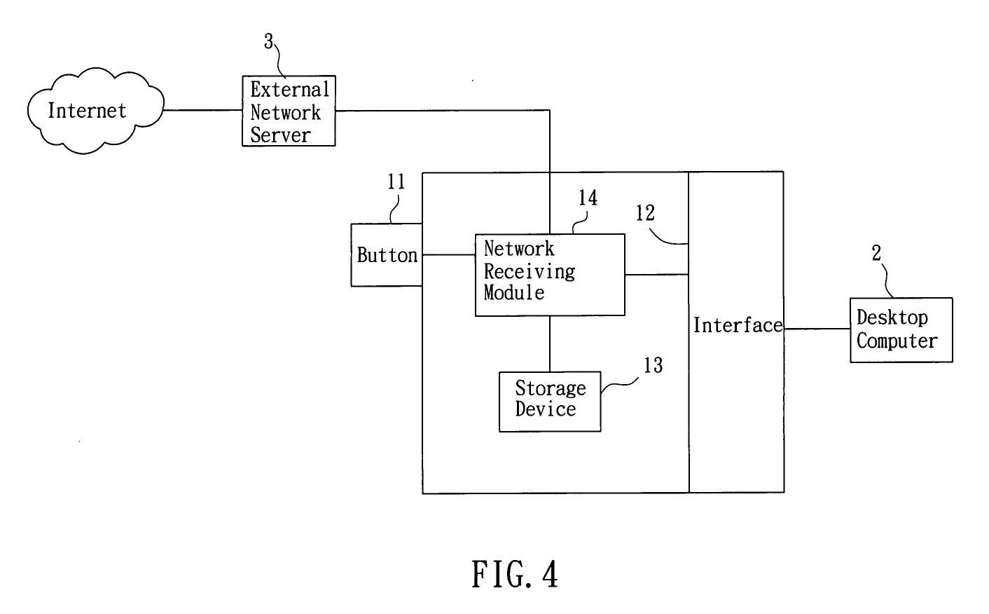

Please refer to FIG. 4, which is a schematic view of the second embodiment of the present invention. As seen in FIG. 4, the network interface card 1 is connected to a desktop computer so as to rapidly access to the Internet through a wired communication network such as an Asymmetric Digital Subscriber Line (ADSL). In the preferred embodiment, the external network server 3 is a registered server of an Internet Service Provider (ISP). It is required to gain the authorization from the ISP before a user can access to the Internet therethrough and the ISP will charge the user by the registered time. Therefore, each user of the ISP will be granted with a specific account number and an identification code. In addition, a user can previously download and edit the connection information consisting of the account number and the identification code to the network interface card using a download program while downloading a connection program thereto from the ISP as well.

As the button 11 is being pressed while a connection 31 is not yet established, the connection program will be initiated for transmitting the connection information to a server 3, and then the connection 31 can be established if the connection information is certified by the server 3. The network interface card 1 is capable of actively informing the electronic device 2, i.e. the desktop computer, with the establishment of the connection 31 while the connection 31 is established, or the operation system (OS), such as Window 2000, of the desktop computer is capable of detecting the establishment of the connection 31.

In addition, as the network interface card is connected to a desktop computer, the connection information is first being compared with a primal connection information stored inside the desktop computer and the establishing of the connection 31 will be stopped by the network interface card 1 while the connection information is not matched with the primal connection information. In a preferred embodiment of the invention, not only the establishing of the connection 31 is stopped, but also the connection information is deleted for security measure.

In the Taiwan Pat. No. 37655, an electronic device capable of connecting to a server by pressing a button is disclosed. However, the abovementioned electronic device is used for simplifying the audio inquiry process that is required to activate a pre-paid card on a mobile phone and is achieved by recoding every button-pressing operation with respect to the audio inquiry process so as to be used for the next pre-paid card activation. Thus, it is noted that the invention disclosed in the Taiwan Pat. No. 37655 requires at least a learning process. On the other hand, the connection method and system of the present invention can download information required for establishing a connection to the network interface card so that it can connect to the Internet rapidly by pressing a button and without any learning process.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A connection method for a network interface card, for the network interface card connecting to an electronic device, the network interface card having a button, a connection information and a connection program, the connection method comprising the steps of:
initiating the connection program by pressing the button;
transmitting the connection information to an external network server by the operation of the connection program;
establishing a connection with the external network server; and
connecting the electronic device to the external network server through the connection by using the network interface card.

2. The method of claim 1, further comprising the step of:
disconnecting the connection by pressing the button.

3. The method of claim 1, wherein the transmitting further comprises the step of: comparing the connection information with a primal connection information stored inside the electronic device.

4. The method of claim 3, wherein the connection is disconnected while the connection information is not matched with the primal connection information

5. The method of claim 1, further comprising the step of:
informing the electronic device by the network interface card with the establishment of the connection while the connection between of the electronic device and the external network server is established.

6. The method of claim 1, further comprising the step of:
detecting the establishment of the connection by the operation system of the electronic device while the connection between of the electronic device and the external network server is established.

7. The method of claim 1, wherein the connection information comprising an account number and an identification code for an apparatus selected from the group consisting of an Access Point Name (APN) and a server of an Internet Service Provide (ISP).

8. The method of claim 1, wherein the electronic device further comprises a download program for editing the connection information and downloading the connection information to the network interface card.

9. A network interface card, adapted for connecting to an electronic device, comprising:
a button;
an interface, for coupling to the electronic device;
a storage device, for storing a connection information and a connection program; and
a network receiving module, connecting to the interface, the storage device and the button, for establishing a connection between the electronic device and an external network server through the interface;
wherein, by pressing the button before the connection is established, the network receiving module is activated to execute the connection program enabling the connection information to be transmitted to the external network server for gaining the authorization of establishing the connection from the external network server, and by pressing the button after the connection is established, the connection is disconnected.

10. The network interface card of claim 9, further comprising:
an indication lamp, for displaying the status of the connection.

11. The network interface card of claim 9, wherein the electronic device further comprises a download program for editing the connection information and downloading the connection information to the network interface card.

12. The network interface card of claim 9, wherein external network server is a device selected from the group consisting of an Access Point Name (APN) and a registered server of an Internet Service Provide (ISP).

13. The network interface card of claim 12, wherein the connection information comprises a registered account number and an identification code.

14. The network interface card of claim 9, wherein the network receiving module compares the connection information with a primal connection information stored inside the electronic device and stopping the establishing of the connection while the connection information is not matched with the primal connection information.

15. The network interface card of claim 9, wherein the network receiving module is capable of informing the electronic device with the establishment of the connection while the connection is established.

16. The network interface card of claim 9, wherein the operation system (OS) of the electronic device is capable of detecting the establishment of the connection.
